(19) United States
(12) Patent Application Publication
(10) Pub. No.: US 2011/0281151 A1
(43) Pub. Date: Nov. 17, 2011

(54) BATTERY PACK

(75) Inventor: Dong-Wook Lee, Yongin-si (KR)

(73) Assignee: Samsung SDI Co., Ltd., Yongin-si (KR)

(21) Appl. No.: 12/971,990

(22) Filed: Dec. 17, 2010

Related U.S. Application Data
(60) Provisional application No. 61/334,089, filed on May 12, 2010.

(51) Int. Cl. H01M 2/24; H01M 10/04

(52) U.S. Cl. 429/158; 29/623.1

(57) ABSTRACT

A battery pack comprises: a plurality of secondary batteries, wherein each battery comprises a terminal; and a tab coupling a terminal of a first secondary battery to a terminal of a second secondary battery; wherein a first end of the tab comprises a first region having a first welding portion and a second region having a second welding portion, and wherein the first and second regions of the first end of the tab are separated by a first space.

### RELATED APPLICATIONS

This application claims the benefit of U.S. Provisional Application No. 61/334,089, filed on May 12, 2010, the disclosure of which is incorporated herein in its entirety.

### BACKGROUND

1. Field

One or more embodiments of the present invention relate to a battery pack, and more particularly, to a battery pack including a tab coupling a terminal of a first secondary battery to a terminal of a second secondary battery.

2. Description of the Related Technology

Secondary batteries typically include lithium-based oxides as positive electrode active materials and carbonaceous materials as negative electrode active materials. In general, according to the type of electrolyte used, secondary batteries can be categorized into liquid electrolyte batteries and polymer electrolyte batteries. Batteries using a liquid electrolyte are called lithium ion batteries, and batteries using a polymer electrolyte are called lithium polymer batteries. In secondary batteries, a bare cell formed by sealing a can housing an electrode assembly and an electrolytic solution is typically electrically connected to a protection circuit substrate. The bare cell is typically electrically charged or discharged by a chemical reaction, and the protection circuit substrate typically protects the bare cell by preventing overcharge and over-discharge while controlling charge and discharge of the bare cell. The battery pack typically includes a plurality of secondary batteries arranged in series or parallel. In this regard, the secondary batteries may be electrically connected by a coupling tab or the like.

### SUMMARY

One or more embodiments of the present invention relate to a battery pack, and more particularly, to a structure of a battery pack including a coupling tab.

According to an embodiment of the present invention, the battery pack comprises a plurality of secondary batteries, wherein each battery comprises a terminal; and a tab coupling a terminal of a first secondary battery to a terminal of a second secondary battery; wherein a first end of the tab comprises a first region having a first welding portion and a second region having a second welding portion, and wherein the first and second regions of the first end of the tab are separated by a first space.

According to another embodiment, a method of forming a battery pack comprises: providing a plurality of secondary batteries, wherein each battery comprises a terminal; and coupling a tab between a terminal of a first secondary battery and a terminal of a second secondary battery; wherein a first end of the tab comprises a first region having a first welding portion and a second region having a second welding portion, and wherein the first and second regions of the first end of the tab are separated by a first space.

### BRIEF DESCRIPTION OF THE DRAWINGS

FIG. 1 is a schematic perspective view of a battery pack according to an embodiment of the present invention.

FIG. 2 is a partially exploded and enlarged perspective view of FIG. 1.

FIG. 3 is a plan view of a coupling tab according to an embodiment of the present invention.

FIG. 4A is a schematic sectional view taken along a line 4a-4a′ of FIG. 3.

FIG. 4B is a schematic sectional view taken along a line 4b-4b′ of FIG. 3.

FIG. 5 is a schematic perspective view illustrating a relation between a coupling tab and welding rods.

FIG. 6 is a schematic sectional view illustrating a welding process in which a coupling tab is welded by welding rods.

FIG. 7A is a first modified example of an embodiment as illustrated in FIG. 4A.

FIG. 7B is a second modified example of an embodiment as illustrated in FIG. 4B.

FIG. 8 is a first modified example of an embodiment as illustrated in FIG. 2.

### DETAILED DESCRIPTION

Hereinafter, embodiments of the present invention will be described in detail with reference to the attached drawings.

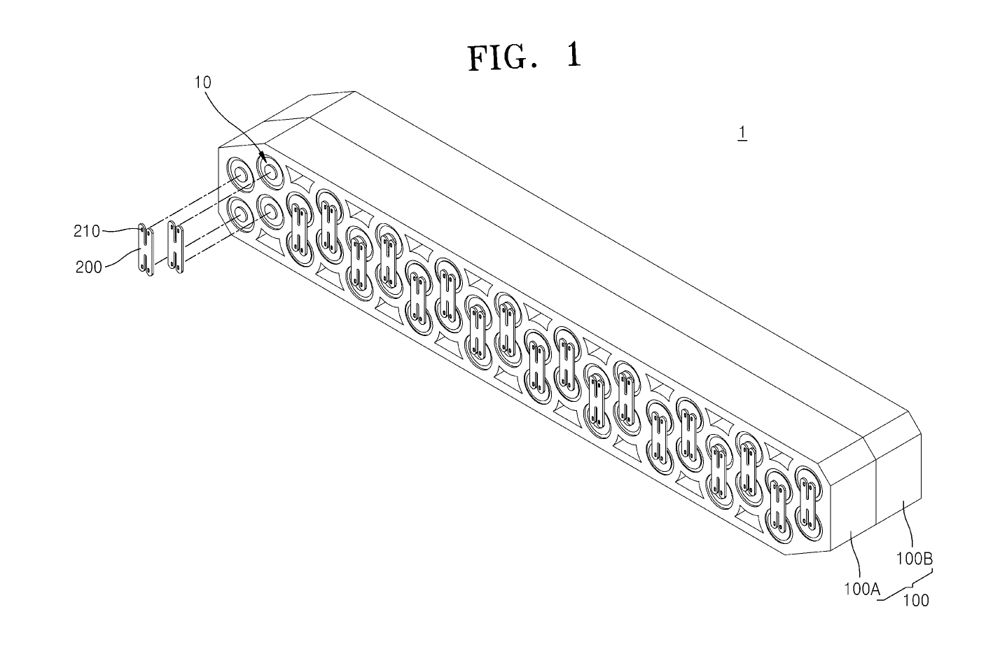

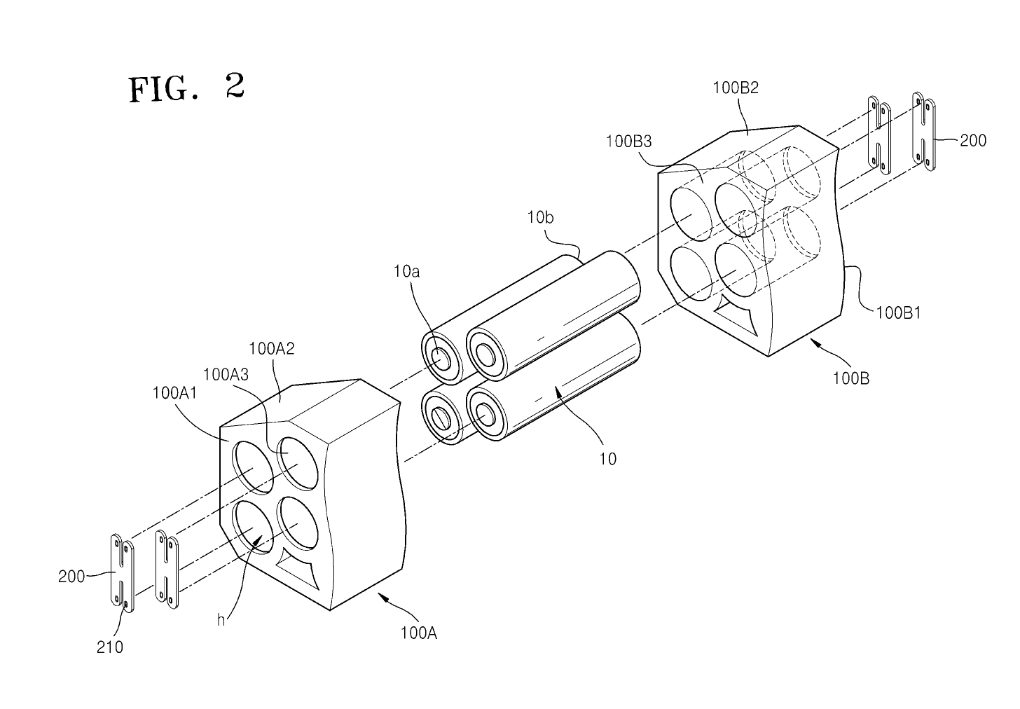

FIG. 1 is a schematic perspective view of a battery pack 1 according to an embodiment of the present invention. FIG. 2 is a partially exploded and enlarged perspective view of FIG. 1.

According to an embodiment, the battery pack 1 includes a plurality of secondary batteries 10 and a case 100. The secondary batteries 10 may form a rechargeable battery assembly. In this regard, each secondary battery 10 may be, for example, a nickel-cadmium (Ni—Cd) battery, a nickel-hydrogen (Ni—MH) battery, or a lithium (Li) secondary battery. Lithium ion secondary batteries typically have operation voltages about three times higher than those of nickel-cadmium batteries, which are generally used as power sources for portable electronic devices, and those of nickel-hydrogen batteries. Lithion ion secondary batteries generally have high energy density per unit weight and can therefore be widely used. An output current and an output voltage of a single secondary battery 10 may be increased by connecting a plurality of secondary batteries in series or parallel. In this regard, the shape of the secondary batteries 10 may be rectangular or cylindrical.

Referring to FIG. 2, although the shape of the embodiment of the present invention is described as cylindrical secondary batteries, the shape of the secondary batteries 10 is not limited thereto. Each of secondary batteries 10 may include terminals 10a and 10b at both ends for electrical contacts to the external device. However, the location of the terminals 10a and 10b on the secondary battery may not be limited to the embodiments illustrated in FIG. 1 or 2. For example, the cylindrical or rectangular secondary batteries 10 may include the terminals 10a and 10b on an end or a side surface thereof for an electric contact with the external device.

The disposition direction of the secondary battery 10 may vary. Referring to FIG. 1, every four secondary batteries 10 are disposed in the same direction according to an embodiment. However, the disposition direction is not limited thereto. For example, the secondary batteries 10 may be disposed in alternative directions in every two or six secondary batteries.

The case 100 may include an upper case 100A and a lower case 100B. In this regard, the case 100 may accommodate the secondary batteries 10 therein or pull the secondary batteries 10 therefrom by coupling or separating of the upper case 100A and the lower case 100B as illustrated in FIG. 2. The case 100 may include a material that does not conduct electricity, such as plastic. Alternatively, the case 100 may have a frame including metal such as aluminum, and a surface of the frame may be coated with a material that insulates electricity. In this regard, the upper case 100A and the lower case 100B may include plates 100A1 and 100B1, side walls 100A2 and 100B2, and guide rails 100A3 and 100B3, respectively. In this regard, the plates 100A1 and 100B1, the side walls 100A2 and 100B2, and the guide rails 100A3 and 100B3 may be coupled together by a separable component or may be integrated to form one body. In this regard, the upper case 100A and the lower case 100B may be symmetrical to each other.

Referring to FIG. 2, the plates 100A1 and 100B1 each have holes h according to an embodiment. In this regard, the hole h may be formed to corresponding with the ends of the secondary batteries 10. Accordingly, the terminals 10a and 10b of each secondary battery 10 may be electrically connected through the holes h of the plates 100A1 and 100B1 with the external device. In addition, the secondary batteries 10 may be connected in series or parallel through the hole h.

As described above, the cases 100A and 100B respectively including the plates 100A1 and 100B1, side walls 100A2 and 100B2, and guide rails 100A3 and 100B3 may be coupled to the secondary batteries 10. In addition, the coupled secondary batteries 10 may be connected to each other in series or parallel by connecting the coupling tab 200 to the terminals 10a and 10b of the secondary battery 10. In this regard, the coupling tab 200 may be coupled to the terminals 10a and 10b of the secondary battery 10 by welding. For example, the coupling tab 200 may be coupled to the terminals 10a and 10b of the secondary battery 10 by resistance welding. The resistance welding may be performed by using, for example, a projection melding method. The projection welding may be, for example, performed in a way that the current passage is restricted by the shape of a structure of the parts being welded, such as an embossed shape.

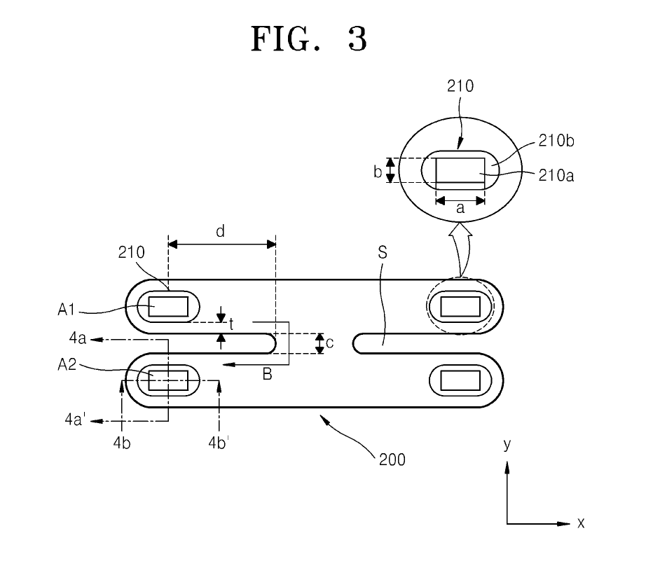

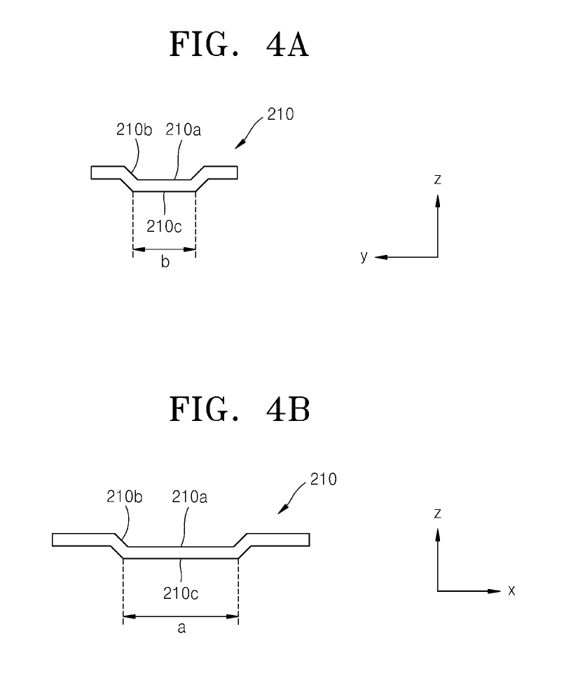

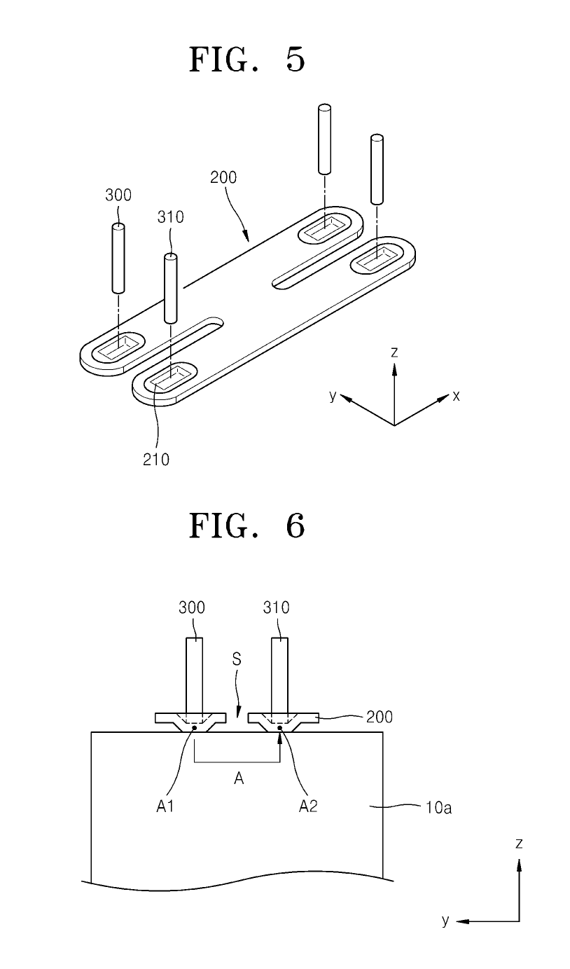

FIG. 3 is a plan view of the coupling tab 200 according to an embodiment of the present invention. FIG. 4A is a schematic sectional view taken along a line 4a-4a′ of FIG. 3. FIG. 4B is a schematic sectional view taken along a line 4b-4b′ of FIG. 3. FIG. 5 is a schematic perspective view illustrating a relation between the coupling tab 200 and welding rods 300 and 310. FIG. 6 is a schematic sectional view illustrating a welding process in which the coupling tab 200 is welded to the terminal 10a of the secondary battery 10 using welding rods.

With respect to the welding process, a side surface of an embossing portion could be easily destroyed after the welding. When the side surface of the embossed portion is destroyed after welding, tension may be reduced although a nugget is formed. To solve this problem, according to an embodiment of the present invention, the coupling tab 200 can have a structure such that the strength of adherence between the coupling tab 200 and the terminals 10a and 10b may increase and destruction of the side surface of the embossed portion after welding may decrease. Referring to FIG. 3, illustrating a plan view of the coupling tab 200 according to an embodiment of the present invention, the coupling tab 200 may have welding portions 210 that have an oval shape. One welding portion 210 and another welding portion 210 may be separated by a slit S. According to an embodiment of the present invention, the coupling tab 200 may have, for example, a letter ‘H’ shape as illustrated in FIG. 3. Referring to FIG. 3, the coupling tab 200 may include four welding portions 210 and a slit S may be formed between neighboring welding portions 210.

The welding portion 210 may include a first plane 210a and an inclined plane 210b. A circumference of the welding portion 210 may have an oval shape in a plan view thereof, and the first plane 210a inside the oval structure may be rectangular and may be formed inside the welding portion 210. In this regard, ends of the welding rods 300 and 310 may contact the first plane 210a of the coupling tab 200, and the inclined plane 210b can safely guide the welding rods 300 and 310 to the first plane 210a.

The rectangular first plane 210a can have a length of a first direction x and a length of a second direction y, respectively referred to as a and b. In this regard, the first plane 210a can extend along the first direction x and thus have a degree of freedom so that the welding rods 300 and 310 contacting the first plane 210a are moveable. If the first plane 210a is quadrilateral or circular, the degree of freedom for movement of the welding rods 300 and 310 would be limited and thus automatic or manual movement of the welding rods 300 and 310 would require a higher level of control. If the welding rods 300 and 310 and the coupling tab 200 are misaligned or have contact errors with respect to each other, a side surface of an embossed portion could be destroyed. Accordingly, the extension of the first plane 210a in the first direction x can allow for a higher degree of freedom of the welding rods 300 and 310, and thus stability can be improved. For example, referring to FIG. 5, the welding rods 300 and 310 can have a degree of freedom such that when the welding rod 300 contacts the coupling tab 200, the welding rod 300 can move along the first direction x. Thus, even when the welding rods 300 and 310 are misaligned within the margins of error, structurally, the position error of the welding rods 300 and 310 may be controlled. In this regard, for example, a ratio of a, the length of the first plane 210a in the first direction x to b, the length of the first plane 210a in the second direction y may be in the range of about 1.5:1 to 3:1. For example, the ratio of a to b may be about 1.7:1.

In this regard, having the extension direction of the first plane 210a in the first direction x may be advantageous compared to having the direction in the second direction y. This is because the distance t between the welding portion 210 and an edge of the coupling tab 200 should ensure a predetermined length or more for safety reasons. If the first plane 210a extends in a direction of the second direction y, it may be difficult to retain t, the distance between the welding portion 210 and the edge of the coupling tab 200, to be a predetermined value or more. Accordingly, the first plane 210a may extend in the first direction x.

In addition, the first plane 210a may be a plane having a straight line. When the first plane 210a is a plane having a straight line, the ends of the welding rods 300 and 310 may properly contact the first plane 210a. If the first plane 210a is curved, the first plane 210a and the welding rods 300 and 310 may have a contact error and thus a side surface of an embossed portion may be easily destroyed after welding. In this regard, a second surface 210c of the coupling tab 200 disposed in an opposition direction (−z) to a third direction may also be a flat plane. Due to the flat plane surface of the second surface 210c, it can be ensured that the coupling tab 200 contacts the terminals 10a and 10b of the secondary battery 10. That is, the coupling tab 200 can contact the surface of the terminals 10a and 10b such that the coupling tab 200 does not slide with respect to the terminals 10a and 10b.

Hereinafter, a slit S formed between the welding portions 210 according to embodiments will be described in detail. Referring to FIG. 6, the coupling tab 200 may contact the terminal 10a, and electricity having a predetermined current and voltage is provided to the coupling tab 200 from the first welding rod 300 and the second welding rod 310, thereby flowing a current from a first spot A1 to second spot A2 of the coupling tab 200, that is, along passage A as shown in FIG. 6. In this regard, heat may occur by resistance generated between the coupling tab 200 and the terminal 10a, and thus welding can be performed. If the slit S is not formed, a current can flow from the first spot A1 to the second spot A2, that is, an opposition direction (−y) of the second direction, and the flowing current may be a wattless current that does not affect welding. Since a space may be formed between the first spot A1 and the second spot A2 by the slit S and thus a current can flow along passage A, a wattless current may be decreased due to the slit S. In addition, referring to FIG. 3, the slit S may be formed to extend in the first direction x, and thus, passage B may be formed to be longer than passage A, thereby inducing a current to flow along passage A, not passage B. That is, since a current is likely to flow along a shorter passage and the B passage extends in the first direction x by the slit S, a current at the first spot A1 may be induced to flow through passage A, not passage B. In this regard, in FIG. 3, a ratio of a width c of the slit S to a distance d between a center of the welding portion 210 and a split point of the slit S may be in the range of about 1:3 to 1:10, for example, about 1:6.5. However, the ratio of c:d may not be limited thereto.

Accordingly, wattless currents flowing in other directions can be reduced and thus more current can flow along the passage A. Since a large amount of current flows along passage A, an electric resistance between the welding portion 210 and the terminal 10a can be increased and more heat can be generated. In this regard, a welding clump formed by fusing the welding portion 210 with the terminal 10a by heat dissipation, that is, a large welding nugget can be formed. In this regard, the amount of heat of the welding portion 210 may be proportional to a square of the current flowing from the welding rods 300 and 310. Accordingly, since the coupling tab 200 may be welded to the terminal 10a by a large welding nugget with a high welding strength, the coupling tab 200 may be more strongly welded to the terminal 10a.

In this regard, the coupling tab 200 may be formed of, for example, a conductive metal including any one kind of metal or a plurality of metals selected from the group consisting of nickel, nickel alloy, iron, iron alloy, stainless, zinc, zinc alloy, copper, copper alloy, silver, silver alloy, gold, gold alloy, platinum, platinum alloy, aluminum, aluminum alloy, molybdenum, molybdenum alloy, tungsten, tungsten alloy, titanium, titanium alloy, beryllium, berylium alloy, rhodium, and rhodium alloy.

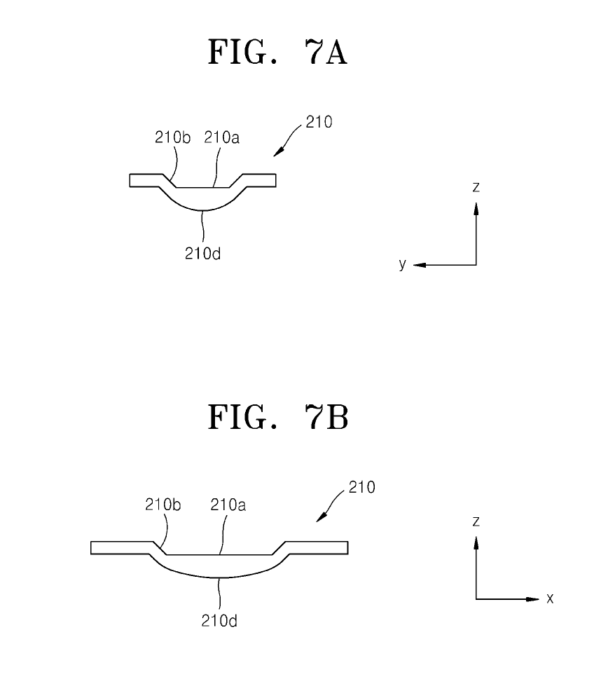

With reference to FIG. 7A or 7B, modified examples of an embodiment of the present invention will be described in detail. FIG. 7A is a first modified example of the embodiment illustrated in FIG. 4A, and FIG. 7B is a second modified example of the embodiment illustrated in FIG. 4B. Referring to FIG. 7A or 7B, the welding portion 210 may include the first plane 210a and the inclined surface 210b, and the third surface 210d disposed in an opposition direction (−z) to the third direction of the coupling tab 200. The third surface 210d may be curved. In this regard, when the curved third surface 210d is welded to the terminal 10a by a resistance, the third surface 210d may have a planar shape corresponding to the shape of the terminal 10a.

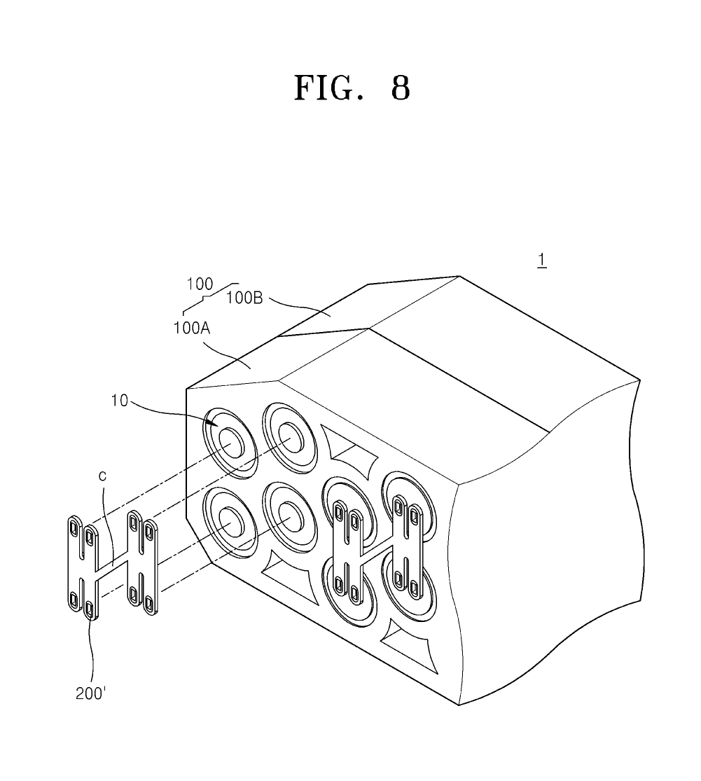

Although the coupling tab 200 having a letter ‘H’ shape is illustrated in FIG. 3, the shape of the coupling tab 200 is not limited thereto. For example, two coupling tabs 200 may be connected to each other by a connection portion C. FIG. 8 is a first modified example of the embodiment illustrated in FIG. 2. In this regard, the coupling tab 200 may have various shapes according to the number and arrangement of the secondary batteries 10 included in a battery pack (1), and the coupling tab 200 may be welded to the secondary battery 10 through various numbers of the welding portions 210, and the location of the welding portions of the coupling tab 200 may vary.

During welding, the welding current amount, current flowing time, and a pressure between the welding rods 300 and 310 and the coupling tab 200 may be variously controlled.

It should be understood that certain embodiments described therein should be considered in a descriptive sense only and not for purposes of limitation. Descriptions of features or aspects within each embodiment should typically be considered as available for other similar features or aspects in other embodiments.

What is claimed is:

1. A battery pack comprising:
a plurality of secondary batteries, wherein each battery comprises a terminal; and
a tab coupling a terminal of a first secondary battery to a terminal of a second secondary battery;
wherein a first end of the tab comprises a first region having a first welding portion and a second region having a second welding portion, and wherein the first and second regions of the first end of the tab are separated by a first space.

2. The battery pack of claim 1, wherein the first and second regions of the first end of the tab are coupled to the first secondary battery.

3. The battery pack of claim 1, wherein a second end of the tab comprises a third region having a third welding portion and a fourth region having a fourth welding portion, and wherein the third and fourth regions of the second end of the tab are separated by a second space.

4. The battery pack of claim 3, wherein the third and fourth regions of the second end of the tab are coupled to the second secondary battery.

5. The battery pack of claim 1, wherein each of the first and second welding portions comprises a width aligned to a shorter side of the space and a length aligned to a longer side of the space, wherein the length is longer than the width.

6. The battery pack of claim 5, wherein the ratio of the length to the width of the welding portions ranges from 1.5:1 to 3:1.

7. The battery pack of claim 1, wherein the space extends from edges of the first and second regions to an interior region of the tab, and wherein the space comprises a width between the first and second regions of the tab, and the width is smaller than a distance between a center of the first or second welding portion and the interior region of the tab.

8. The battery pack of claim 7, wherein the ratio of the width of the space to the distance between the center of the first or second welding portion and the interior region of the tab ranges from 1:3 to 1:10.

9. The battery pack of claim 1, wherein each of the welding portions comprises a flat inner surface facing away from the terminals, and an inclined surface facing away from the terminals and surrounding the flat inner surface.

10. The battery pack of claim 9, wherein each of the welding portions further comprises a flat surface facing the terminals.

11. The battery pack of claim 10, wherein each of the welding portions further comprises at least a partially curved surface facing the terminals.

12. The battery pack of claim 1, wherein the tab further couples terminals of the first and second secondary batteries to a terminal of a third secondary battery and to a terminal of a fourth secondary battery.

13. The battery pack of claim 1, wherein the tab comprises a predetermined distance between each of the welding portions and the space.

14. The battery pack of claim 1, wherein each of the welding portions comprises a surface that protrudes outwardly towards the terminal.

15. A method of forming a battery pack comprising:
providing a plurality of secondary batteries, wherein each battery comprises a terminal; and
coupling a tab between a terminal of a first secondary battery and a terminal of a second secondary battery;
wherein a first end of the tab comprises a first region having a first welding portion and a second region having a second welding portion, and wherein the first and second regions of the first end of the tab are separated by a first space.

16. The method of claim 15, wherein the coupling of the tab comprises projection welding the tab to the terminals of the first and second secondary batteries through the first and second welding portions.

17. The method of claim 15, wherein the coupling of the tab comprises welding the tab to the terminals of the first and second secondary batteries through the first and second welding portions, wherein the first and second welding portions each comprises a flat surface facing the terminals.

18. The method of claim 15, wherein a second end of the tab comprises a third region having a third welding portion and a fourth region having a fourth welding portion, and wherein the third and fourth regions of the second end of the tab are separated by a second space.

19. The method of claim 15, wherein each of the first and second welding portions comprises a width aligned to a shorter side of the space and a length aligned to a longer side of the space, wherein the length is longer than the width.

20. The method of claim 15, wherein the space comprises a width between the first and second regions, and the width is smaller than a length between centers of the first or second welding portions and an interior region of the tab.
